(19) United States
(12) Patent Application Publication
(10) Pub. No.: US 2021/0232918 A1
(43) Pub. Date: Jul. 29, 2021

(54) NODE AGGREGATION WITH GRAPH NEURAL NETWORKS

(71) Applicant: NEC Laboratories America, Inc., Princeton, NJ (US)

(72) Inventors: Wei Cheng, Princeton Junction, NJ (US); Haifeng Chen, West Windsor, NJ (US); Wenchao Yu, Plainsboro, NJ (US)

(21) Appl. No.: 17/158,092

(22) Filed: Jan. 26, 2021

Related U.S. Application Data
(60) Provisional application No. 62/967,072, filed on Jan. 29, 2020.

(51) Int. Cl. G06N 3/08; G06N 3/04

(52) U.S. Cl. CPC G06N 3/08; G06N 3/04

(57) ABSTRACT

Methods and systems for training a graph neural network (GNN) include training a denoising network in a GNN model, which generates a subgraph of an input graph by removing at least one edge of the input graph. At least one GNN layer in the GNN model, which performs a GNN task on the subgraph, is jointly trained with the denoising network.

This application claims priority to U.S. Patent Application No. 62/967,072, filed on Jan. 29, 2020, incorporated herein by reference entirety.

### BACKGROUND

### Technical Field

The present invention relates to graph neural networks, and, more particularly, to and more particularly to denoising graph neural networks by dropping task-irrelevant edges.

### Description of the Related Art

Data about the physical world can be represented in graphs, which can be challenging to work with, as they may include rich relational information between nodes, beyond just the node feature information itself. While graph neural networks (GNNs) can aggregate information in graph data, such approaches may be vulnerable to poor quality in a given graph. GNNs may be over-smoothed and over-fitted.

### SUMMARY

A method for training a graph neural network (GNN) includes training a denoising network in a GNN model, which generates a subgraph of an input graph by removing at least one edge of the input graph. At least one GNN layer in the GNN model, which performs a GNN task on the subgraph, is trained jointly with the denoising network.

A system for training a GNN includes a hardware processor and a memory that stores computer program code, which, when executed by the processor, implements a GNN model and a model trainer. The GNN model includes a denoising network, which generates a subgraph of an input graph by removing at least one edge of the input graph, and at least one GNN layer, which performs a GNN task on the subgraph. The model trainer trains the GNN model using a training data set.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram showing denoising a graph by removing edges between nodes belonging to different classes, in accordance with an embodiment of the present invention;

FIG. 2 is a block/flow diagram of a method for denoising an input graph and performing a GNN task, in accordance with an embodiment of the present invention;

FIG. 3 is a block/flow diagram of the operation of a GNN that includes denoising networks to process an input graph, in accordance with an embodiment of the present invention;

FIG. 4 is a block diagram of a computer network security system that uses a GNN model and denoising networks, in accordance with an embodiment of the present invention;

FIG. 5 is a diagram of high-level artificial neural network architecture that may be used to implement a GNN, in accordance with an embodiment of the present invention; and

FIG. 6 is a diagram of an exemplary computer network, including at least one system that shows anomalous activity, in accordance with an embodiment of the present invention.

### DETAILED DESCRIPTION OF PREFERRED EMBODIMENTS

Information may be recursively propagated along edges of a graph. However, real-world graphs are often noisy, and may include task-irrelevant edges, which can lead to suboptimal generalization performance in a learned graph neural network (GNN) model. To address this, a parameterized topological denoising network may be used. Robustness and generalization performance of GNNs may thereby be improved by learning to drop task-irrelevant edges, which can be pruned by penalizing the number of edges in a sparsified graph with parameterization networks. To take into account the topology of the entire graph, a nuclear norm regularization may be applied, thereby imposing a low-rank constraint on the resulting sparsified graph.

These improvements in graph handling provide improvements to GNN performance in various tasks, such as node classification and link prediction. By denoising an input graph, the task-irrelevant edges can be pruned to avoid aggregating unnecessary information in GNNs. This also helps to alleviate the over-smoothing that can occur with GNNs.

Using a deep neural network model, structural and content information from a graph are considered, and the model is trained to drop task-irrelevant edges. The denoised graph can then be used in a GNN for robust learning. The sparsity that is introduced in the graph has a number of advantages: a sparse aggregation is less complicated and therefore generalizes well, and sparsity can facilitate interpretability and help to infer task-relevant neighbors.

This process can be made compatible with various GNNs, in both transductive and inductive settings, for example by relaxing a discrete constraint with continuous distributions that can be optimized efficiently with backpropagation. The denoising networks and the GNN may be jointly optimized in an end-to-end fashion. Thus, rather than removing edges randomly, or according to pre-defined heuristics, denoising may be performed in accordance with the supervision of the downstream objective in the training phase.

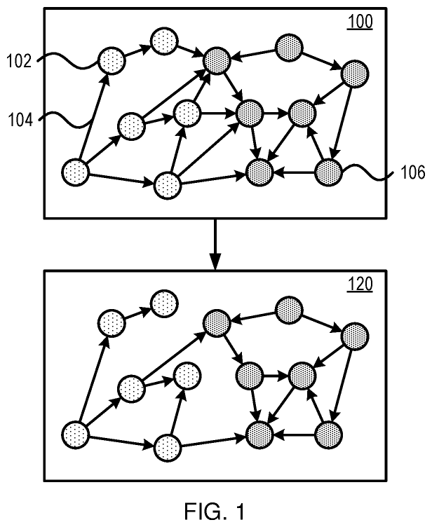

Referring now to FIG. 1, an example of graph pruning is shown. An input graph 100 is pruned to produce a denoised graph 120. Each graph includes a number of first nodes 102, and number of second nodes 106, and connections 104 between the nodes. In denoising the graph, certain connections 104 are removed, for example connections between certain first nodes 102 and certain second nodes 106.

The graphs described herein may be defined as G=(υ, ε), where υ represents the set of nodes in the graph and where ε represents the set of edges in the graph that connect pairs of nodes. An adjacency matrix on G may be defined as A∈ [symbol] ^{n×n}, wherein n is the number of nodes in υ. Node features may be defined according to the matrix X∈ [symbol] ^{n×m}, where m is the dimensionality of the node features. The matrix Y may be used to denote the labels in a downstream task. For example, in a node classification task, Y∈ [symbol] ^{n×c}, where c is the number of classes.

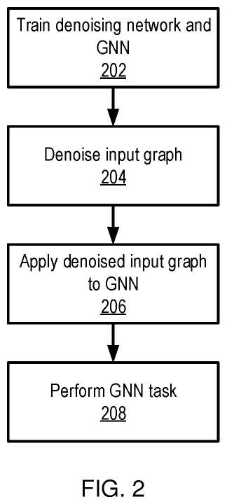

Referring now to FIG. 2, a method for performing a GNN task is shown, including denoising input graphs before using them in the GNN task. Block 202 trains a denoising network and a GNN, for example jointly, in an end-to-end fashion. The two networks can then be trained together to provide good results on a set of training data.

For new input graphs, block 204 first denoises the input graph using the trained denoising network. As noted above, this may remove edges from the input graph that are not relevant to the task. Block 206 then provides the denoised input graph to the GNN. The GNN will perform whatever task it has been trained to do, such as graph classification.

The output of the GNN is used by block 208 to perform some GNN task. For example, if the GNN is trained to perform classification of the input graphs, then block 208 may take an action based on that classification. In one specific, non-limiting example, the input graph may represent a computer network, with nodes representing individual systems in the computer network, and with edges representing communications between the systems. In such an example, classification may be performed to determine whether the current state of the computer network, encoded as the graph, represents anomalous behavior, such as a network intrusion or a system failure. The GNN task 208 may therefore detect such anomalous behavior and correct it.

Another example of GNN task 208 may include node labeling within a network graph that is only partially labeled to start. In such a task, the input graph may have some nodes that are not labeled, and the GNN task 208 may infer labels, for example identifying a function of the node. Node labeling may also be employed to identify anomalous behavior, for example by locating specific systems within a computer network that are behaving abnormally.

The GNN task 208 may include a variety of actions. For example, the task 208 may include a security action, responsive to the detection of anomalous behavior in a computer system. This security action may include, for example, shutting down devices, stopping or restricting certain types of network communication, raising alerts to system administrators, changing a security policy level, and so forth.

Although the GNN task 208 is described herein with particular attention to the context of computer network security, it should be understood that the present principles may be applied to any context that employs GNNs. Denoising the input graph may improve the performance of any GNN task.

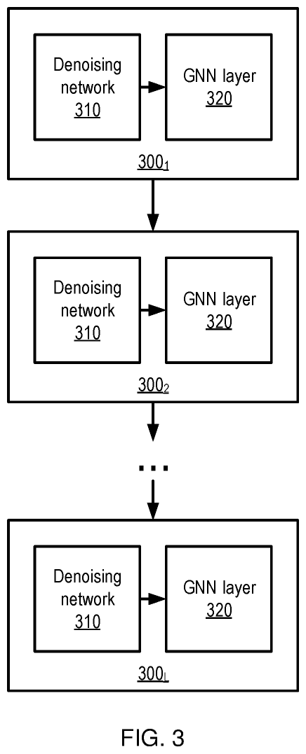

Referring now to FIG. 3, layers 300 may each include a denoising network 310 and a GNN layer 320. The denoising network 310 may be a multi-layer network that samples a sub-graph from a learned distribution of edges and outputs the sub-graph as a denoised graph. With relaxation, the denoising networks 310 may be differentiable and may be jointly optimized with the GNN layers 320, guided by supervised downstream signals. At each stage, the GNN layer 320 outputs an embedding vector for a node. The next layer uses the embeddings in the previous layer to learn the embedding vectors of nodes in the current layer. The final node embeddings are provided by the last layer's embedding, and these final node embeddings can be used to perform the task.

The subgraph output by the denoising networks 310 may filter out task-irrelevant edges before the subgraph is provided to the GNN layer(s) 320. For the l^{th} GNN layer 320, a binary matrix is introduced Z^{l}∈{0,1}^{|υ|×|υ|}, with z_{u,v}^{l} denoting whether an edge between u and v is present. A value of zero for z_{u,v}^{l} indicates a noisy edge.

The adjacency matrix of the resulting subgraph is A^{l}=A ⊙Z^{l}, where ⊙ is the element-wise product. One way to reduce noisy edges with the fewest assumptions about A^{l} is to directly penalize the number of non-zero entries in Z¹ of different layers:

$${\sum }_{l = 1}^{L} {‖ {Z}^{l} ‖}_{0} = {\sum }_{l = 1}^{L} {\sum }_{( u , v ) ∈ ɛ} 𝕀 [ {z}_{u , v}^{l} \neq 0 ]$$

where [symbol] [⋅] is an indicator function, with [symbol] [True]=1 and [symbol] [False]=0, and where ∥⋅∥ is the [symbol] ₀ norm. There are 2^{|ε|} possible states of Z^{l}. Optimizing this penalty directly may be computationally intractable, due to its nondifferentiability and combinatorial nature.

As such, each binary number π_{u,v}^{l} may be assumed to be drawn from a Bernoulli distribution, parameterized by π_{u,v}^{l}, such that z_{u,v}^{l}·Bern(π_{u,v}^{l}). The matrix of π_{u,v}^{l} may be denoted by Π^{l}. Penalizing the non-zero entries in Z^{l}, for example representing the number of edges being used, can be reformulated as regularizing Σ_{(u,v)∈ε}π_{u,v}^{l}.

Since π_{u,v}^{l} may be optimized jointly with the downstream task, it may describe the task-specific quality of the edge (u, v). A small value for π_{u,v}^{l} may indicate that the edge (u, v) is more likely to be noise, and may therefore be weighted lower or even removed entirely in the following GNN layer. Although regularization of the reformulated form is continuous, the adjacency matrix of the resulting graph may still be generated by a binary matrix Z^{l}.

The expected cost of a downstream task may be modeled as L({Π^{l}}ₗ₌₁^{L})= [symbol] _{z}_{^{l}}_{˜p(Π}_{¹}_{), . . . , z}_{^{L}}_{˜p(Π}_{^{L}}₎f({Z^{l}}ₗ₌₁^{L}, X), where L is the number of layers and l∈[1, . . . , L]. To efficiently optimize subgraphs, reparameterization may be used and the binary entries z_{u,v}^{l} may be relaxed from being drawn from a Bernoulli distribution. The entries z_{u,v}^{l} may instead be drawn from a deterministic function of parameters α_{u,v}^{l}∈ [symbol] and an independent random variable ∈^{l}. Thus, z_{u,v}^{l}=g(α_{u,v}^{l},∈^{l}). The gradient may then be calculated as:

$${Δ}_{{α}_{u , v}^{l}} {𝔼}_{{ϵ}^{1} , … , {ϵ}^{L}} f ( \{ g , X \} ) = {Δ}_{{α}_{u , v}^{l}} {𝔼}_{{ϵ}^{1} , … , {ϵ}^{L}} [ ( \frac{\partial f}{\partial g} ) ( \frac{\partial g}{\partial {α}_{u , v}^{l}} ) ]$$

For induction, it is beneficial to determine more than that an edge should be dropped—determining why it should be dropped is helpful. To learn to drop, for each edge (u,v), parameterized networks may model the relationship between the task-specific quality π_{u,v}^{l} and the node information, including node contents and topological structure. In the training phase, denoising networks and GNNs may be jointly optimized. In testing, the input graphs may also be denoised with the learned denoising networks. To compute a subgraph of the input graph, the time complexity of the denoising network in the inference phase may be linear with the number of edges: O(|ε|).

A parameter a_{u,v}^{l} may be learned to control whether to remove the edge (u, v). Focusing on a node u in a graph from the training dataset, the term [symbol] ᵤ identifies the neighbors of u. For the l^{th} GNN layer 320l, a_{u,v}^{l} may be calculated for nodes u and v∈ [symbol] ᵤ as a_{u,v}^{l}=f_{θl}^{l}(hᵤ^{l},hᵥ^{l}) where f_{θl}^{l} may be a multi-layer perceptron parameterized by θ^{l}. To get z_{u,v}^{l}, a concrete distribution may be used, along with a hard sigmoid function. First, s_{u,v}^{l} may be drawn from a binary concrete distribution, with a_{u,v}^{l} parameterizing the location. Formally, this may be expressed as:

$$ϵ \sim Uniform ( 0 , 1 ) , {s}_{u , v}^{l} = σ ( \frac{( log ϵ - log ( 1 - ϵ ) + {α}_{u , v}^{l} )}{τ} )$$

Where s_{u,v}^{l} is a parameter that controls where a given edge is removed, τ∈ [symbol] ⁺ indicates a temperature hyper-parameter to control the sparsity of removing edges, and

$$σ ( x ) = \frac{1}{1 + {e}^{- x}}$$

is the sigmoid function. With τ>0, the function is smoothed with a well-defined gradient ∂s_{u,v}^{l}/∂α_{u,v}^{l}, enabling efficient optimization of the parameterized denoising network 310.

Because the binary concrete distribution has a range of (0,1), to encourage the weights for task-specific noisy edges to have values of exactly zero, the range may be extended to (γ,ζ), where γ<0 and ζ>1. Then z_{u,v}^{l} may be computed by clipping the negative values to 0 and by clipping values larger than 1 to 1. Thus:

s̅_{u,v}^{l}=t(s_{u,v}^{l})=s_{u,v}^{l}(ζ−γ)+γ,z_{u,v}^{l}=min(1,maz(s̅_{u,v}^{l},0))

The constraint on the number of non-zero entries in Z¹ can be reformulated with:

$${ℛ}_{c} = {\sum }_{l = 1}^{L} {\sum }_{( u , v ) ∈ ɛ} ( 1 - {ℙ}_{{\overline{s}}_{u . v}^{l}} ( 0 \vert {θ}^{l} )$$

where [symbol] s̅_{u,v}^{l}(0/θ^{l}) is the cumulative distribution function (CDF) of s̅_{u,v}^{l}. The density of s_{u,v}^{l} may be expressed as:

$${𝒫}_{{s}_{u , v}^{l}} ( x ) = \frac{( τ {α}_{u , v}^{l} {{x}^{- τ - 1} ( 1 - x )}^{- τ - 1} )}{{( {α}_{u , v}^{l} {x}^{- τ} + {( 1 - x )}^{- τ} )}^{2}}$$

The CDF of s_{u,v}^{l} may be expressed as:

[symbol]

s_{u,v}^{l}(x)=σ((logx−log(1−x))τ−a_{u,v}^{l})

Since the function s̅_{u,v}^{l}=t(s_{u,v}^{l}) is monotonic, the probability density function of s̅_{u,v}^{l} may be expressed as:

$${𝒫}_{{s}_{u , v}^{l}} ( x ) = {𝒫}_{{s}_{u , v}^{l}} ( {t}^{- 1} ( x ) ) \vert \frac{\partial }{\partial x} {t}^{- 1} ( x ) \vert = \frac{( ζ - γ ) ( τ {{α}_{u , v}^{l} ( x - γ )}^{- τ - 1} {( ζ - x )}^{- τ - 1} )}{{( {{α}_{u , v}^{l} ( x - γ )}^{- τ} + {( ζ - x )}^{- τ} )}^{2}}$$

Similarly, the CDF of s̅_{u,v}^{l} may be expressed as:

$${ℙ}_{{\overline{s}}_{u , v}^{l}} ( x ) = {ℙ}_{{s}_{u , v}^{l}} ( {t}^{- 1} ( x ) ) = σ ( ( log x - γ - log ( ζ - x ) ) τ - {α}_{u , v}^{l} )$$

By setting x=0, the result is:

$${ℙ}_{{\overline{s}}_{u , v}^{l}} ( 0 \vert {θ}^{l} ) = σ ( τ log ( - \frac{γ}{ζ} ) - {α}_{u , v}^{l} )$$

When training the denoising network 310 and the GNN layers 320 in block 202, the input may include a training graph G, with node features X, a number of GNN layers L, and a set of labels Y for the downstream task. A denoised subgraph G_{d} may be determined by the denoising network 310. In this example, the networks may be trained to predict labels for use in GNN task 208. The input graph G may be divided into minibatches.

The following pseudocode represents an example of training the networks:

```
for each minibatch do
    for l ← 1 to L do
          G_{d} = ( [symbol]  , ε_{d}) // subgraph of G, sampled by l^{th}
          denoising network
          310
          Feed G_{d} to l^{th} GNN layer 320
          determine hidden representations H^{l}
    end for
    determine prediction {ŷ|ν ϵ [symbol]  } with H^{l}
    determine loss(Ŷ, Y) and regularizers
    update parameters of GNN layers 320 and denoising networks 310
end for
```

In certain datasets, nodes from multiple classes can be divided into different clusters. Nodes from different topological communities are more likely to have different respective labels. Hence, edges connecting multiple communities are more likely to represent noise for GNNs. A low-rank constraint can therefore be imposed on the adjacency matrix of the denoised sub-graph to enhance the generalizability and robustness of the model, since the rank of the adjacency matrix reflects the number of clusters. This regularization denoises the input graph from the global topology perspective, by encouraging the denoising networks to remove edges that connect multiple communities, such that the resulting sub-graphs have dense connections within communities, while connections are sparse between communities. Notably, graphs with low ranks are more robust to network attacks.

A regularizer [symbol] ₗᵣ for implementing a low-rank constraint may be Σₗ₌₁^{L}Rank(A^{l}), where A^{l} is the adjacency matrix for the l^{th} GNN layer. This may be approximated with the nuclear norm, which is the convex surrogate for the NP-hard matrix rank minimization problem. The nuclear norm of a matrix is defined as the sum of its singular values, and is a convex function that can be optimized efficiently. Nuclear norm constraints tend to produce very low-rank solutions. With nuclear norm minimization, the regularization may be expressed as:

$${ℛ}_{lr} = {\sum }_{l = 1}^{L} {‖ {A}^{l} ‖}_{*} = {\sum }_{l = 1}^{L} {\sum }_{i = 1}^{\vert 𝒱 \vert} \vert {λ}_{i}^{l} \vert$$

where λᵢ^{l} is the i^{th} largest singular value of the graph adjacency matrix A^{l}.

Singular value decomposition (SVD) can help to optimize the nuclear norm regularization. However, SVD may lead to unstable results during backpropagation. The partial derivatives of the nuclear norm may be found by computing a matrix M^{l}, with elements:

$${m}_{ij}^{l} = \{ \begin{matrix}1 / ( {( {λ}_{i}^{l} )}^{2} - {( {λ}_{j}^{l} )}^{2} ) , & i \neq j \\ 0 , & i = j\end{matrix}$$

When (λᵢ^{l})²−(λⱼ^{l})² is small, then the partial derivatives become very large, leading to an arithmetic overflow. Power iteration may therefore be used, with a deflation procedure. Power iteration approximately computes the largest eigenvalue and the dominant eigenvector of the matrix (A^{l})*A^{l}, with an iterative procedure from a randomly initiated vector, where (A^{l})* is the transpose-conjugate of A^{l}.

The largest singular value of A^{l} is then the square root of the largest eigenvalues. To calculate other eigenvectors, the deflation procedure iteratively removes the projection of the input matrix on this vector. However, power iteration may output inaccurate approximations if two eigenvalues are close to one another. This becomes more challenging when eigenvalues near zero are considered.

SVD and power iteration may therefore be combined, and the nuclear norm may further be relaxed to a K-norm, which is the sum of the top K largest singular values, 1≤K<<|V|. In the forward pass, SVD is used to calculate singular values, left and right singular vectors. The nuclear norm is then used as the regularization loss. To minimize the nuclear norm, the power iteration is used to compute the top K singular values, denoted by \tilde{λ}₁^{l}, . . . , \tilde{λ}_{K}^{l}. Power iteration does not update the values in singular vectors and singular values—it serves to compute the gradients during backpropagation. The nuclear norm can then be estimated with [symbol] ₗᵣ=Σₗ₌₁^{L}Σᵢ₌₁^{K}|\tilde{λ}ᵢ^{l|. The regularizer} [symbol] ₗᵣ is a lower bound function of [symbol] ᵢᵣ with gap:

$${ℛ}_{lr} - {\tilde{ℛ}}_{lr} = {\sum }_{l = 1}^{L} {\sum }_{i = K + 1}^{\vert 𝒱 \vert} \vert {\tilde{λ}}_{i}^{l} \vert = {\sum }_{l = 1}^{L} {\sum }_{i = K + 1}^{\vert 𝒱 \vert} \vert {λ}_{i}^{l} \vert \leq ( \vert 𝒱 \vert - K ) {\sum }_{l = 1}^{L} \vert {λ}_{K + 1}^{l} \vert$$

The upper bound of [symbol] ₗᵣ may be

$$⌈ \frac{\vert 𝒱 \vert}{K} ⌉ .$$

The constant coefficient may be disregarded and [symbol] ₗᵣ: may be minimized as the low-rank constraint.

The following pseudo-code may be implemented to perform a forward pass to compute the nuclear norm. The input may include the adjacency matrix A^{l} and an approximate hyper-parameter K, and the output may be the nuclear norm loss [symbol] ₗᵣ:

```
    for l ← 1 to L do
      (U^{l})Λ^{l}(V^{l})* ← SVD(A^{l}) //dismiss gradients at backpropagation
      B ← (A^{l})*A^{l}
      for i ← 1 to K do
        vᵢ^{l} ← PI(B, vᵢ^{l})
        ${\tilde{λ}}_{i}^{l} ← \sqrt{\frac{[ {( {v}_{i}^{l} )}^{T} {Bv}_{i}^{l} ]}{[ {( {v}_{i}^{l} )}^{T} {v}_{i}^{l} ]}}$
        B ← B − Bvᵢ^{l}(vᵢ^{l})^{T} //deflation
      end for
    end for [symbol]
ₗᵣ ← Σₗ₌₁^{L}Σᵢ₌₁^{K}|\tilde{λ}ᵢ^{l}|
```

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

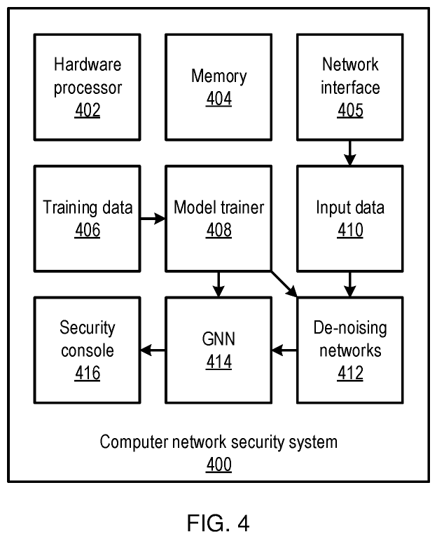

Referring now to FIG. 4, a computer network security system 400 is shown. It should be understood that this system 400 represents just one application of the present principles, and that other uses for denoised graph inputs to GNNs are also contemplates. The system 400 includes a hardware processor 402 and a memory 404. A network interface 405 communicates with one or more other systems on a computer network by, e.g., any appropriate wired or wireless communication medium and protocol.

A model trainer 408 uses a set of training data 406, which may be stored in the memory 404, to train the denoising networks 412 and the GNN layers 414, as described above. New input data 410 may be received from the network interface 405, reflecting the current state of the computer network. This information may include, for example, network log information that tracks physically connections between systems, as well as communications between systems. The network log information can be received in an ongoing manner from the network interface 405 and can be processed to identify changes in network topology (both physical and logical) and to collect information relating to the behavior of the systems.

This input data 410 is denoised by denoising networks 412 and is processed by GNN layers 414, as described above, to analyze the information about the computer network and to provide some sort of output, such as a classification of anomalous activity. In some embodiments, the GNN layers 414 can identify systems in the network that are operating normally, and also systems that are operating anomalously. For example, a system that is infected with malware, or that is being used as an intrusion point, may operate in a manner that is anomalous. This change can be detected as the network evolves, making it possible to identify and respond to security threats within the network.

A security console 416 receives the output and performs a security action responsive to it. The security console 416 reviews information provided by the GNN layers 414, for example by identifying anomalous systems in the network, and triggers a security action in response. For example, the security console 416 may automatically trigger security management actions such as, e.g., shutting down devices, stopping or restricting certain types of network communication, raising alerts to system administrators, changing a security policy level, and so forth. The security console 416 may also accept instructions from a human operator to manually trigger certain security actions in view of analysis of the anomalous host. The security console 416 can therefore issue commands to the other computer systems on the network using the network interface 405.

As noted above, the denoising networks 412 and the GNN layers 414 may be implemented as an artificial neural network (ANN). An ANN is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

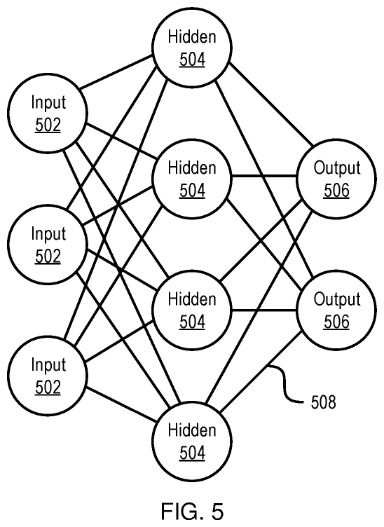

Referring now to FIG. 5, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 502 that provide information to one or more “hidden” neurons 504. Connections 508 between the input neurons 502 and hidden neurons 504 are weighted, and these weighted inputs are then processed by the hidden neurons 504 according to some function in the hidden neurons 504. There can be any number of layers of hidden neurons 504, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 506 accepts and processes weighted input from the last set of hidden neurons 504.

This represents a “feed-forward” computation, where information propagates from input neurons 502 to the output neurons 506. Upon completion of a feed-forward computation, the output is compared to a desired output available from training data. The error relative to the training data is then processed in “backpropagation” computation, where the hidden neurons 504 and input neurons 502 receive information regarding the error propagating backward from the output neurons 506. Once the backward error propagation has been completed, weight updates are performed, with the weighted connections 508 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 508 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

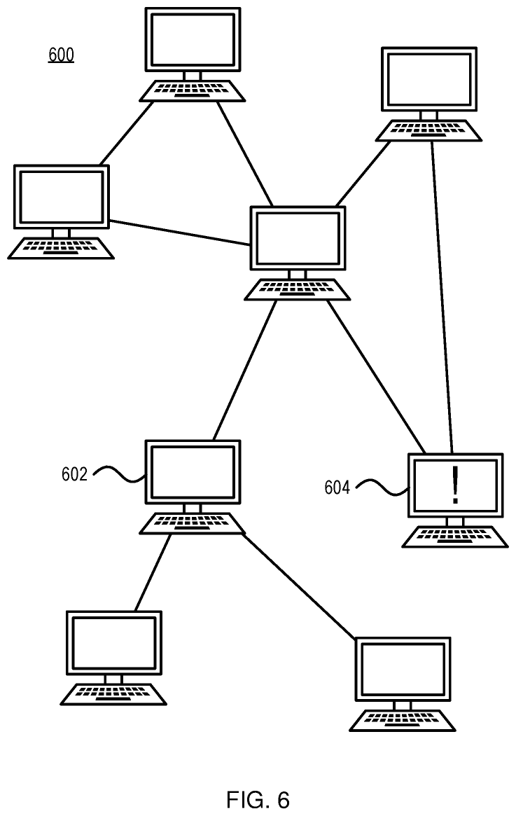

Referring now to FIG. 6, an embodiment is shown that includes a network 600 of different computer systems 602. The functioning of these computer systems 602 can correspond to the labels of nodes in a network graph that identifies the topology and the attributes of the computer systems 602 in the network. At least one anomalous computer system 604 can be identified using these labels, for example using the labels to identify normal operation and anomalous operation. In such an environment, the GNN model can identify and quickly address the anomalous behavior, stopping an intrusion event or correcting abnormal behavior, before such activity can spread to other computer systems.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a graph neural network (GNN), comprising:
training a denoising network in a GNN model, which generates a subgraph of an input graph by removing at least one edge of the input graph using a low-rank constraint; and
training at least one GNN layer in the GNN model, which performs a GNN task on the subgraph, jointly with the denoising network.

2. The method of claim 1, wherein the GNN model includes multiple denoising networks and multiple GNN layers, with each of the multiple denoising networks providing an input to a respective one of the multiple GNN layers.

3. The method of claim 2, wherein each of the multiple GNN layers outputs a respective embedding vector for a denoised graph.

3. The method of claim 2, wherein each of the multiple denoising networks processes a different minibatch sampled from the input graph.

5. The method of claim 1, wherein the low-rank constraint includes a nuclear norm.

6. The method of claim 5, wherein the low-rank constraint removes edges between nodes of differing classes from the input graph.

7. The method of claim 5, wherein applying the low-rank constraint includes minimizing the nuclear norm using a combination of singular value decomposition and power iteration.

8. The method of claim 7, wherein minimizing the nuclear norm includes minimizing the function:
$${\tilde{ℛ}}_{lr} = {\sum }_{l = 1}^{L} {\sum }_{i = 1}^{K} \vert {\tilde{λ}}_{i}^{l} \vert$$
where L is a number of layers of the GNN model, λᵢ^{l} is the i^{th} largest singular value of a graph adjacency matrix A^{l}, and K is a number of largest singular values consider.

9. The method of claim 1, wherein the GNN task is node classification, to classify nodes of the input graph according to whether they are normal or abnormal.

10. The method of claim 1, wherein the GNN task is link prediction, to determine whether an edge exists between two nodes in the input graph.

11. A system for training a graph neural network (GNN), comprising:
a hardware processor; and
a memory that stores computer program code, which, when executed by the processor, implements:
a GNN model that includes a denoising network, which generates a subgraph of an input graph by removing at least one edge of the input graph using a low-rank constraint, and at least one GNN layer, which performs a GNN task on the subgraph; and
a model trainer that trains the GNN model using a training data set.

12. The system of claim 11, wherein the GNN model includes multiple denoising networks and multiple GNN layers, with each of the multiple denoising networks providing an input to a respective one of the multiple GNN layers.

13. The system of claim 12, wherein each of the multiple GNN layers outputs a respective embedding vector for a denoised graph.

13. The system of claim 12, wherein each of the multiple denoising networks processes a different minibatch sampled from the input graph.

15. The system of claim 11, wherein the low-rank constraint includes a nuclear norm.

16. The system of claim 15, wherein the low-rank constraint removes edges between nodes of differing classes from the input graph.

17. The system of claim 15, wherein the model trainer minimizes the nuclear norm using a combination of singular value decomposition and power iteration.

18. The system of claim 17, wherein the model trainer minimizes the function:
$${\tilde{ℛ}}_{lr} = {\sum }_{l = 1}^{L} {\sum }_{i = 1}^{K} \vert {\tilde{λ}}_{i}^{l} \vert$$
where L is a number of layers of the GNN model, λᵢ^{l} is the i^{th} largest singular value of a graph adjacency matrix A^{l}, and K is a number of largest singular values consider.

19. The system of claim 11, wherein the GNN task is node classification, to classify nodes of the input graph according to whether they are normal or abnormal.

20. The system of claim 11, wherein the GNN task is link prediction, to determine whether an edge exists between two nodes in the input graph.
